(19) United States
(12) Patent Application Publication
(10) Pub. No.: US 2011/0139182 A1
(43) Pub. Date: Jun. 16, 2011

(54) DETERGENT USE

(76) Inventors: Paul Lapham, Tyne and Wear (GB); Eric San Jose Robles, Newcastle upon Tyne (GB); Gillian Margaret Hardy, Newcastle upon Tyne (GB); Mark Stewart Slassor, Newcastle upon Tyne (GB)

(21) Appl. No.: 12/965,132

(22) Filed: Dec. 10, 2010

(30) Foreign Application Priority Data
Dec. 10, 2009 (EP) 09178726.7

(51) Int. Cl. B08B 3/04; C11D 3/60; C11D 17/00

(52) U.S. Cl. 134/18; 510/220; 510/221; 134/104.1

(57) ABSTRACT

Use of an automatic dishwashing product in an automatic dishwasher for cleaning the internal parts of a dishwasher during an automatic dishwashing operation wherein the operation involves the delivery of at least 250 ppm of a non-ionic surfactant.

### TECHNICAL FIELD

The present invention is in the field of cleaning. In particular, it relates to automatic dishwashing cleaning; more particularly, to automatic dishwashing products comprising a high level of a non-ionic surfactant and its use for the cleaning of internal parts of the dishwashing machine during an automatic dishwashing operation.

### BACKGROUND

Dishwashers have to deal with a great amount of soils coming from soiled dishware, tableware and cookware. The soils are usually complex mixtures of food residues and they can accumulate in different parts of the dishwasher. This can contribute to the partial or total blockage of internal parts of the dishwasher impairing in the performance of the appliance and in some cases even breaking down the dishwasher.

There are products specifically designed to clean the main body of the dishwasher. These products are mainly designed to remove lime scale from the main body of the dishwasher rather than residues from the internal parts of the dishwasher. These products usually require to be used when the dishwasher is empty and they require the use of an additional wash (i.e., increased energy and water consumption). The use of an extra product to clean and care for the dishwasher is found to be an extra task for the dishwasher user.

Hitherto there is not an automatic dishwashing detergent that helps with the maintenance of the dishwasher. An objective of this invention is to provide a product capable of achieving good cleaning of dishware/tableware/cookware and at the same time good cleaning and care of the body and the internal parts of the dishwasher to extend the life and efficiency of the dishwasher.

### SUMMARY OF THE INVENTION

According to a first aspect of the invention, there is provided the use of an automatic dishwashing product comprising a high level of non-ionic surfactant for cleaning the internal parts of a dishwasher. The product is used during an automatic dishwashing operation, i.e., in the presence of a dishwashing load (i.e. soiled dishware, tableware and/or cookware), thus avoiding the need to run the dishwasher empty in order to clean the dishwasher. The benefit is achieved each single time that a loaded dishwasher is run.

The present invention provides excellent cleaning and finishing of the dishwashing load and at the same time the main body and most surprisingly, the internal parts of the dishwasher. The use of the invention contributes to the maintenance and good appearance of the dishwasher. It also extends the life of the machine and keeps the efficiency of the machine higher for longer.

A dishwasher basically consists of a main body sometimes also referred to as “tub”. Usually the main body is made of stainless steel and/or plastic having two racks to place the dirty load and two spray arms that spray water on the soiled load. The arms rotation is generated by a water pump. Once the load has been sprayed, the dirty dishwashing liquor is pumped out. The pump(s) and the drains from and to the pump(s) of the dishwasher are herein referred to as “internal parts”.

There are no products either in the literature or in the market that clean and/or care for the internal parts (i.e., pump and drain pipes to and from the pump) of the dishwasher. Traditionally, it has been thought that the dishwashing detergent only contributes to the cleaning of the dishwashing load and cannot have effect on the internal parts of the machine. It is also a common belief that food residues deposit on the internal parts of the dishwasher and that this is a normal part of the tear and wear of the machine. Dishwasher users tackle problems related to dishwashing performance by calling engineers that physically replace old parts. In the present invention the internal parts of the dishwasher are kept in better conditions for longer periods of time, reducing or even obviating the replacement of internal parts and thereby extending the life of the dishwasher and keeping its initial efficiency for longer.

Traditionally, the automatic dishwasher formulator has designed products to remove soils from the dishwashing load but he does not consider what happens with the soils once they have left the load. Food soils can accumulate over time in the dishwasher pump and/or drain pipes giving rise to deposits that can impair the dishwashing efficiency and it could finally result in a total break down of the dishwasher.

Grease, if not completely emulsified with surfactant, can form oil droplets that can coalesce to form a film. The grease can also hydrolyse into fatty acids which in turn can interact with water hardness ions to produce scum. Solidified grease either on its own or in combination with other food residues and/or ions can build up on the internal parts of the machine, especially on the pump and drains, impairing the performance of the dishwasher and finally it can even end up with the break down of the dishwasher. As indicated before, it has been thought that this is part of the wear and tear of the machine. The present inventors have found that this does not need to be the case if the right detergent is used.

The level of non-ionic surfactant herein is critical. It needs to provide cleaning and finishing of the dishwashing load and at the same time remove and/or avoid deposit formation on the internal parts of the dishwasher. The level of surfactant should not be too high because it can impair the shine of the washed items, it can contribute to filming and clouding of the washed items, this is more noticeable on glass and plastic items. The benefit provided by the present invention requires the delivery in the wash liquor of at least 250 ppm (i.e. mg/l) of a non-ionic surfactant, preferably at least 300 ppm, more preferably at least 400 ppm and specially at least 500 ppm. The dishwashing product should provide less than 1500 ppm of non-ionic surfactant, preferably less than 1000 ppm of non-ionic surfactant. Especially preferred level of non-ionic surfactant is from about 300 to about 700 ppm. The non-ionic surfactant can be a single non-ionic surfactant or a surfactant system, i.e., a mixture of two or more different surfactants. Preferred for use herein is a surfactant system.

Greasy soils are usually present in every dishwashing load. Grease can be dispersed or melted with the high temperatures reached during the dishwashing operation. Without being bound by theory, it is believe that once the grease is liquefied, it forms oil droplets that get suspended by the non-ionic surfactant, the non-ionic surfactant avoids the coalescence of the droplets and thereby preventing film formation. The surfactant of the invention needs to be robust enough not only to suspend the grease on the dishwashing liquor but also to keep it suspended all the way through so it does not deposit on the internal parts of the dishwasher. The washing liquor travels from the interior of the dishwasher to the drain. The trajectory from the dishwasher to the drain involves changes of temperature. The surfactant needs to keep the grease suspended in the dishwashing liquor across the whole range of temperature to which the dishwashing liquor is exposed otherwise grease would re-solidify and form deposits that would build up over each wash, especially once the wash temperature goes below the melting point of the grease.

Traditionally, non-ionic surfactants have been used in automatic dishwashing for surface modification purposes in particular for sheeting to avoid filming and spotting and to improve shine. It has now been found that high level of non-ionic surfactant (at least 250 ppm preferably at least 300 ppm, more preferably at least 400 ppm, especially from about 300 to about 700 ppm) can also contribute to prevent deposition of soils not only on washed items but also on dishwasher parts, including internal parts. As pointed out before this provides enormous benefits in terms of machine care and avoids the blockage of internal parts of the dishwasher and contributes to a more effective cleaning. This more effective cleaning is particularly evident in the case of bleachable stains. It has been found that when the internal parts of a dishwasher are dirty the removal of bleachable stains from the dishwashing load is negatively affected. Without being bound by theory it is believed that depletion of peroxide can happen in the internals part of the dishwasher when the dishwashing liquor is pumped.

The requirements of the non-ionic surfactant for use in the present invention are stricter than those for non-ionic surfactants in a product that only aims to clean a dishwashing load. The non-ionic surfactant of the present invention needs to promote soil suspension, in particular grease suspension and keep the soil and grease suspended not only during the dishwashing operation but also downstream, when the dishwashing liquor gets discharged. During the discharge process the dishwashing liquor starts to cool down. The non-ionic surfactant of the invention needs to suspend the soil and grease and keep it suspended even when the temperature of the dishwashing liquor decreases during the discharge process, in order to avoid deposition of soils and in particular grease on the internal parts of the dishwasher.

The capacity of a surfactant to suspend soils, and in particular to suspend grease, and keep it suspended even when the temperature is below the solidification point of the grease is herein quantified by measuring the obscuration associated to the surfactant/grease system. Obscuration is defined as the amount of laser light blocked and scattered by the particles comprised in a dispersion. i.e., the amount of light that is not transmitted through the dispersion. Thus, the higher the obscuration the better is the soil suspending, and in particular grease suspending capacity, of the surfactant. In order to subject the surfactant to similar conditions to those found in a dishwasher, a solution comprising the surfactant is subjected to a temperature profile ramping from 30° C. to 50° C. and ending at 20° C. The temperatures cited herein have an accuracy of about +/−0.5° C. Meaningful points in order to understand the soil (in particular grease) suspending capacity of a surfactant are 36° C. (close to the lard solidification point) and 20° C., that is usually the lowest temperature achieved during the discharge of the dishwashing liquor.

In preferred embodiments, the obscuration of the surfactant in the presence of 0.75 g of lard is greater at 20° C. than at 36° C. after the surfactant/lard have gone through a 30-50-20° C. temperature cycle. 36° C. herein refers to 36° C. in the cooling period, ie. after the system has reached 50° C. Preferably the comparison is done using an aqueous solution comprising 250 ppm of surfactant, 574 ppm of sodium carbonate, 1896 ppm of sodium tripolyphosphate and 0.75 grams of lard following the method specified herein below.

Preferably, 250 ppm of the surfactant for use herein has a normalized (as defined herein below) obscuration in the presence of 0.75 grams of lard at 36° C. (after the surfactant/lard have gone through a 30-50-20° C. temperature cycle. 36° C. herein refers to 36° C. in the cooling period, ie. after the system has reached 50° C.) greater than 0.8, more preferably greater than 0.9, even more preferably greater than 1 as measured in an aqueous solution containing 574 ppm of sodium carbonate and 1896 ppm of sodium tripolyphosphate.

Preferably, 250 ppm of the surfactant for use herein has a normalized (as defined herein below) obscuration in the presence of 0.75 grams of lard at 20° C. (after the surfactant/lard have gone through a 30-50-20° C. temperature cycle) greater than 0.8, more preferably greater than 0.9, even more preferably greater than 1 as measured in an aqueous solution containing 574 ppm of sodium carbonate and 1896 ppm of sodium tripolyphosphate.

In a preferred embodiment, the non-ionic surfactant has a normalized (as defined herein below) obscuration index of at least about 0.7, preferably at least about 0.8 and more preferably at least about 0.9 wherein the obscuration index is defined as the ratio of obscuration at 36° C. to the obscuration at 20° C. (after the surfactant/lard have gone through a 30-50-20° C. temperature cycle, again 36° C. refers to the cooling period) in the presence of 0.75 grams of lard. Lard is chosen herein because it can be considered to be representative of the greasy soils found in a typical dishwashing load and because it solidifies at room temperature. By “lard” herein is meant white, unsalted, pig fat as classically used for British cooking with a melting temperature in the range of from 36° C. to 45° C. and a density of about 0.9 g/ml. Lard is commonly available in UK supermarkets, for example in Tesco, Sainsbury, Morrison and ASDA. The melting range is determined using a capillary method. This standard method involves a capillary tube containing a column of the lard, that is heated using for example a heated bath equipped with a thermometer. The temperature in the heated bath is ramped at a fixed rate of for example 1° C. until the lard in the tube transitions into the liquid state. The melting range is determined visually.

Interfacial tension is a property that helps to quantify the grease suspension effectiveness of a surfactant. To asses the suspension effectiveness of the surfactant for use in the invention the dynamic interfacial tension has been measured according to the ISO 9101 standard method (with the variations described herein below). The interfacial tension between the surfactant and lard has been measured vs time by taking 13 measurements, with a droplet creation rate range of from 0.07 to 0.50 s/μL. The dynamic interfacial tension decays initially with time until reaching an equilibrium value. The first five measurement points are fitted to a first order exponential decay (y=y0+A1(e−x/t1)). “t1” represents the interfacial tension decay constant. The last five measurement points are averaged to obtain the equilibrium interfacial tension. The first order exponential decay could be fitted using a variety of available software packages, such as Origin software package.

In preferred embodiments the non-ionic surfactant has an interfacial tension decay constant on lard at 50° C. of less than 1.2, more preferably less than 1, more preferably below 0.8 and especially below 0.5 seconds. The interfacial tension decay constant gives an indication of the kinetics of the surfactant system, i.e. how fast the surfactant is able to reach and assemble at the interface thereby improving the products' grease suspending effectiveness. The faster the surfactant the more difficult it would be for the grease to deposit on surfaces.

In preferred embodiments the non-ionic surfactant has an equilibrium interfacial tension on lard at 50° C. of less than 1.4, more preferably of less than 1.2 mN/m. In general, the lower the equilibrium interfacial tension the higher the grease suspending effectiveness of the surfactant.

In especially preferred embodiments the non-ionic surfactant has an interfacial tension decay constant on lard at 50° C. of less than 1.2, more preferably of less than 1, more preferably less than 0.8 and especially less than 0.5 seconds and an equilibrium interfacial tension on lard at 50° C. below 1.5 mN/m, more preferably below 1.2 mN/m. Surfactants having these interfacial tension decay constant and equilibrium interfacial tension perform extremely well in terms of cleaning the internal parts of a dishwasher.

The obscuration, interfacial tension decay constant and equilibrium interfacial tension values apply mutatis mutandis the surfactant of the product of the invention.

In preferred embodiments the surfactant has a cloud point, as measured in 1% wt aqueous solution, in the range of from about 20° to about 50° C., more preferably about 30° to about 45° C. and especially from 35° C. to about 43° C. Preferably, the cloud point of the surfactant is below the wash temperature (usually 50° C.). It is especially preferred when the cloud point of the surfactant is from 5° C. to 10° C. below the wash temperature.

In preferred embodiments the surfactant is a low foaming non-ionic surfactant. By “low foaming non-ionic surfactant” is herein understood a surfactant in a dishwashing liquor at a concentration of 250 ppm in an automatic dishwashing operation that creates suds below 5 cm, more preferably below 3 cm, more preferably below 2 cm, more preferably below 1 cm and specially below 0.5 cm. Suds height is measured in the absence of soils by attaching a ruler to the wall of a dishwasher and measuring the height from the wash liquor to the top of the suds at the end of the main wash.

In preferred embodiments the surfactant comprises an alkoxylated alcohol. Preferably the surfactant is a surfactant system and one of the surfactants of the system is an ethoxylated alcohol having from 8 to 18 carbon atoms and on average from 4 to 14 moles of ethylene oxide, preferably from 5 to 10 moles of ethylene oxide. Preferably the surfactant system comprises at least 20%, more preferably at least 50% and especially at least 80% of an alcohol ethoxylated surfactant by weight of the surfactant system.

Preferably the surfactant is a surfactant system comprising an alkoxylated alcohol having from 8 to 18 carbon atoms and on average from 4 to 14 moles of ethylene oxide, preferably from 5 to 10 moles of ethylene oxide (EO) and/or propylene oxide (PO) and/or butylene oxide (BO) (i.e., the alkoxylated alcohol comprises at least two of the alkoxylated groups EO, PO and BO). Preferably the surfactant system comprises less than 50%, more preferably less than 35% and especially at least 20% by weight of the surfactant system of an alkoxylated alcohol comprising at least two alkoxylated groups selected from EO, PO and BO.

Especially preferred for use herein is a surfactant, preferably a surfactant system comprising at least 30%, more preferably at least 50% and especially at least 80% of an alcohol ethoxylated surfactant by weight of the surfactant system and less than 50%, more preferably less than 35% and especially at least 20% but more than 5% by weight of the surfactant system of an alkoxylated alcohol surfactant comprising at least two alkoxylated groups selected from EO, PO and BO.

In a preferred embodiment, there is provided the use of an automatic dishwashing product for cleaning the internal parts of a dishwasher during an automatic dishwashing operation wherein the product has an obscuration in the presence of 0.75 grams of lard at 20° C. greater than the obscuration at 36° C. (after the detergent/lard have gone through a 30-50-20° C. temperature cycle, again 36° C. refers to the cooling period). Preferably, the product has an obscuration index of at least about 90, preferably at least about 100 and more preferably at least about 110, wherein the obscuration index is defined as the ratio of obscuration at 36° to the obscuration at 20° C. in the presence of 0.75 grams of lard Preferably the product has an interfacial tension decay constant on lard at 50° C. below of less than 1, more preferably less than 0.8 and especially less than 0.5 seconds and more preferably an equilibrium interfacial tension below 1.5, more preferably below 1, even more preferably below 0.9 and especially below 0.8 mN/m.

The obscuration, interfacial tension decay constant and equilibrium interfacial tension values of the surfactant for use in the method of the invention apply mutatis mutandis to the surfactant of the products of the invention.

According to a second aspect of the invention there is provided a phosphate free automatic dishwashing product. The product is capable of providing good cleaning of the interior parts of the dishwasher. The product comprises a high level of non-ionic surfactant, bleach and an anti-scalant polymer, preferably the anti-scalant polymer is a carboxylated polymer. Preferably the phosphate free product comprises a bleach catalyst, more preferably the bleach catalyst is a manganese complex.

The products of the present invention comprise a high level of non-ionic surfactant. By “high level” of non-ionic surfactant is herein meant from about 5% to about 20%, preferably from about 6% to about 18%, more preferably from about 7% to about 16% and especially from about 8% to 14% by weight of the product.

According to another aspect of the invention there is provided an automatic dishwashing product in unit dose form comprising a high level of a non-ionic surfactant wherein the product is selected from: a multi-phase tablet comprising an insert; a single compartment pouch; or a multi-compartment pouch wherein one of the compartments comprises a composition in gel form.

According to another aspect of the invention there is provided an automatic dishwashing product in the form of a water-soluble pouch comprising a high level of a non-ionic surfactant, an oxygen bleach and a manganese bleach catalyst.

As mentioned herein above the surfactant of the products of the invention has the same obscuration interfacial tension decay constant and equilibrium interfacial tension values as the surfactant described herein above. The same applies for the products, i.e., the products of the invention preferably have the same obscuration, interfacial tension decay constant and equilibrium interfacial tension values as the products described herein above.

According to the last aspect of the invention, there is provided a method of automatic dishwashing comprising cleaning the internal parts of a dishwasher during the dishwashing process comprising the step of delivering the detergent composition of the invention to provide at least 250 ppm of non-ionic surfactant, preferably at least 300 ppm, more preferably at least 400 ppm and especially at least 500 ppm. The dishwashing method should provide less than 1500 ppm of non-ionic surfactant, preferably less than 1000 ppm, more preferably less than 800 ppm of non-ionic surfactant.

### BRIEF DESCRIPTION OF THE DRAWINGS

FIG. 1 is a graph related to the MS2000 Obscuration profile of Brig 30: 30-50-20° C. ramp, 0.75 grams lard which shows the percent obscuration in relation to elapsed time.

### DETAILED DESCRIPTION OF THE INVENTION

The present invention envisages the use of an automatic dishwashing product comprising a high level of non-ionic surfactant for cleaning the internal parts of a dishwasher during a normal automatic dishwashing operation. The invention also envisages products comprising high level of non-ionic surfactant that provide cleaning of the internal parts of a dishwasher and a method of providing cleaning of the internal parts of a dishwasher during a normal dishwashing operation. The use, products and method of the invention provide not only a good cleaning and finishing of a dishwashing load but also an outstanding care of the dishwasher.

### Obscuration Measurement

An aqueous solution comprising a surfactant is prepared. Lard is added to this solution to form a dispersion. The obscuration resulting from this dispersion is measured vs time and temperature. The surfactant solution is prepared by making 625 ml of a solution comprising 250 ppm of surfactant in deionised water, 574 ppm of sodium carbonate and 1896 ppm of sodium tripolyphosphate (the carbonate and phosphate are added to simulate the ionic strength of a dishwashing detergent typical formulation).

In the case of an automatic dishwashing product a solution is prepared comprising the finished product (rather than just the surfactant). The resulting solution is filtered to get rid of insoluble material.

The lard is gently heated and then placed into an oven at 50° C., to achieve a lard thermal equilibration temperature of 50° C., before 0.75 g is added to the surfactant solution.

Obscuration is defined as a zero angle turbidity measurement which quantifies the amount of laser light blocked and scattered by the particles present in a dispersion. i.e., the amount of light that is not transmitted through the dispersion. It is akin to absorbance in the case of a spectrophotometer and is directly and linearly proportional to sample concentration.

The obscuration of the surfactant/lard dispersion is measured using a laser diffraction particle sizing instrument (Mastersizer 2000 from Malvern Instruments). The instrument is connected to a jacketed beaker containing the dispersion to be measured (surfactant/lard). The dispersion is re-circulated between the beaker and the sampling cell of the particle sizing instrument where the obscuration is measured.

The jacketed beaker is connected to a thermostatic water bath to control the temperature of the suspension. The initial temperature of the dispersion is 30° C. Then a ramp is commenced where the temperature is taken up to 50° C. (this usually takes about 16 minutes) the dispersion is then cooled to 20° C. (this usually takes about 1 hour and 45 minutes). The heating and cooling rates are substantially linear, preferably linear. Preferably the heating rate is about 1.25° C./min and the cooling rating is about 0.3° C./min. This temperature cycle simulates the working conditions inside an automatic dishwasher. The obscuration index is calculated according to the following formula:

Obscuration index=obscuration at 20° C./obscuration at 36° C. (in the cooling period).

Then the obscuration index is normalized with the obscuration index under the same conditions of Brij 30 surfactant. Brij 30 is 2-(dodecyloxy) ethanol available from Aldrich.

The normalized obscuration index is the quotient of the obscuration index of a given surfactant to the obscuration index of Brij 30 measured under the same conditions.

### Detailed Protocol to Measure Obscuration

The equipment used include: a laser diffraction particle sizing instrument Malvern Mastersizer 2000; a wet dispersion system equipped with an impeller (Malvern Hydro 2000MU) and a jacketed beaker; a thermostatic water bath (e.g. Lauda Ecoline RE320) to feed the jacket of the jacketed beaker and regulate actual sample temperature via an external Pt100 thermocouple with PID feedback loop; and a means of supplementing the water bath cooling rate to achieve the desired cooling ramp target (e.g. Haake EK20 refrigerated immersion coil cooler, frozen “cool packs” or similar).

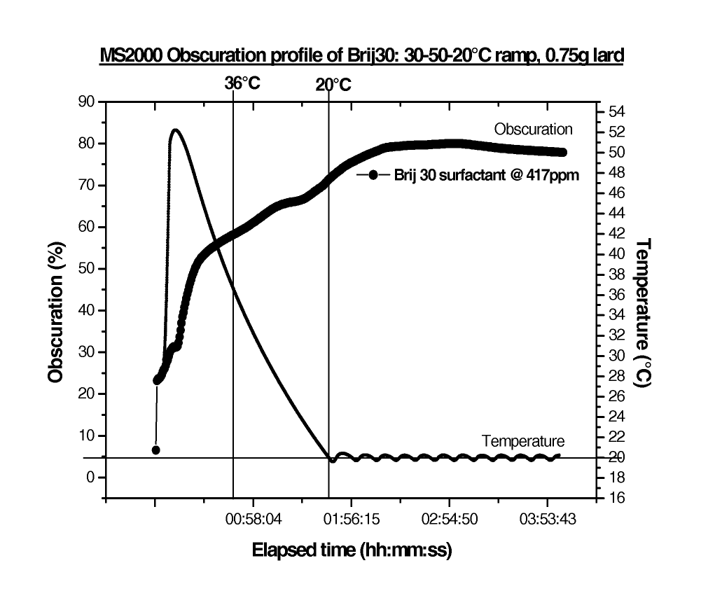

The following steps are used to measure the obscuration of a surfactant/lard system:
1. Switch on Mastersizer 2000 and open software. Allow 30 minute warm up period for laser stabilisation, prior to commencing measurements.
2. 625 ml of the surfactant solution are transferred to the jacketed beaker.
3. The impeller unit is placed into the centre of the jacketed beaker.
4. Stirring at 1400 rpm is started.
5. The surfactant solution is circulated around the measurement cell to equilibrate its temperature with the surfactant solution.
6. Stirring is stopped and started again at 1400 rpm (to facilitate removal of any unwanted air in the system).
7. The speed of the stirrer is increased to 2000 rpm.
8. A thermocouple is inserted into the jacketed beaker.
9. The sample is left to equilibrate at 30° C.
10. When 30° C. is reached the 0.75 g of melted lard is injected into the centre of the beaker and obscuration measurement is commenced.
11. Immediately after, heating of the water bath from 30° C. to 50° C. is commenced (this takes about 16 minutes).
12. When 50° C. is reached, the water bath is immediately adjusted to cool the sample down to 20° C. (this takes about 1 hour and 45 minutes).
13. Steps 1 to 12 are repeated for Brij 30 (FIG. 1 displays the graph for the obscuration of Brij 30 vs time/temperature).
14. The normalized obscuration index is calculated as per above formula using discrete obscuration data points recorded at 36° C. and 20° C. on the cooling cycle.

The following measurement parameters are used:

### Sample—Corn Oil, RI=1.469, Absorption=0

### Dispersant—Water, RI=1.33, Absorption=0

General purpose, normal sensitivity measurement mode
Sample measurement time=10 seconds
Background measurement time=15 seconds
Delay between measurements=10 seconds
Total number of measurement cycles per run=142

To measure the obscuration of an automatic dishwashing product the method is as described above but the surfactant is replaced by the automatic dishwashing product. The product can be in unit dose form or in the form of gel or loose powder, in the case of gel and loose powder the dose recommended by the manufacturer is used. To create the solution the product is placed in a beaker with 5 litre of distilled water at 50° C., the product is left to dissolve for a period of 60 minutes, stifling at 300 rpm without heating (thus allowing the solution to cool from 50° C. to around 35° C. at the end of the 60 minutes, this simulate the conditions found in a dishwasher). After 60 minutes the resulting solution is filtered using a vacuum pump and Hartley funnel to pass the liquor through a Whatman GF/C (coarse) glass microfiber filter. The filtrate is collected and vacuum filter a second time, using a Whatman GF/F (fine) glass microfiber filter.

### Dynamic Interfacial Tension

Dynamic interfacial tension of a surfactant in lard is measured according to ISO 9101:1987(E). Dynamic interfacial tension is the measurement of the volume of a drop of an aqueous phase (solution of deionised water containing a surfactant) formed at the end of a vertical capillary tube when it detaches from the tube in contact with the organic phase (lard). The interfacial tension between the two liquid phases is obtained by balancing the weight of the drop with interfacial tension force supporting it and applying a correction factor; then calculation of the interfacial tension is made from the volume of the falling drop, the outer capillary radius, the density difference between the two liquid phases and the acceleration due to gravity.

The differences between the ISO 9101:198(E) and the method used herein are:

a. Fully automated instrument used, instead of a manually operated syringe
b. Syringe volume=2500 μL instead of 500 μL
c. Thermostat not switched off as droplet approaches maximum volume, as instrument is designed to avoid vibration issues
d. An average of 3 measurements of drop volume per droplet age was taken instead of 4.

To measure the dynamic interfacial tension a Lauda TVT-2, Drop Volume Tensiometer with 2500 μL syringe and a thermostatic water bath control, programmed to deliver 50° C. are used. The lard is placed in the cuvette of the tensiometer and the surfactant in the syringe.

The following steps are used to measure the dynamic interfacial tension of a surfactant in lard:

1. Switch on instrument and program temperature to 50° C.
2. Remove composite lard from fridge and gently melt out on hot-plate.
3. Transfer melted lard to Lauda TVT-2 instrument, filling glass cuvette.
4. Fit protective lid to prevent any contaminants from entering the cuvette.
5. Remove syringe and rinse thoroughly with double-distilled water several times.
6. Slowly fill the syringe with surfactant (or automatic dishwashing detergent product) solution. In the case of an automatic dishwashing detergent product, filter first using a 0.45 μm syringe filter.
7. When filled, invert syringe and evacuate any air bubbles.
8. Mount syringe in tempered block onto instrument.
9. Allow approximately 10 minutes for the whole system to thermally equilibrate at 50° C.
10. Begin measurement using following settings:
2500 μL syringe
Lard density of about 0.9 g/ml
13 measurement cycles, 3 replicate droplets per cycle
Dynamic mode setting
Droplet creation rate range of from 0.07 to 0.50 s/μL

### Non-Ionic Surfactant

The non-ionic surfactant for use herein could be a single surfactant or a surfactant system (i.e. a mixture of surfactants), preferably the non-ionic surfactant is a surfactant system. The present invention allows the skilled person to choose a surfactant based on its obscuration, interfacial tension decay constant and equilibrium interfacial tension, measured as detailed herein above. Preferably the non-ionic surfactant for use herein is low foaming. In the case of a surfactant system, the system should be low foaming rather than each single surfactant constituting the system. Preferably the non-ionic surfactant has a cloud point in the range of from 20° to 50°. In the case of a surfactant system, the system should have the specified cloud point rather than each single surfactant constituting the system.

A preferred non-ionic surfactant is a compound obtained by the condensation of alkylene oxide groups with an organic hydrophobic material which may be aliphatic (linear or branched) or alkyl with cyclic group or alkyl aromatic in nature, preferably is a compound selected from the group consisting of a C2-C18 alcohol alkoxylate having EO, PO and/or BO moieties. The moieties can be in block configuration or randomly distributed.

Preferably the surfactant comprises an alcohol ethoxylated surfactant, substantially free of other alkoxylated groups (i.e. less than 10%, more preferably less than 5% and especially less than 1% of alkoxylated groups other than ethoxy groups). Suitable herein are primary alcohols having preferably from 8 to 18 carbon atoms and on average from 1 to 12 mol of ethylene oxide (EO) per mole of alcohol in which the alcohol radical may be linear or 2-methyl-branched, or may contain a mixture of linear and methyl-branched radicals, as are typically present in oxo alcohol radicals. Preferred alcohol ethoxylated surfactants have linear radicals of alcohols of natural origin having from 12 to 18 carbon atoms, for example, of coconut, palm, tallow fat or oleyl alcohol, and on average from 2 to 8 EO per mole of alcohol. Preferred ethoxylated alcohols include, for example, C12-14-alcohols having 3 EO or 4 EO, C9-11-alcohol having 7 EO, C13-15-alcohols having 3 EO, 5 EO, 7 EO or 8 EO, C12-18-alcohols having 3 EO, 5 EO or 7 EO and mixtures thereof, such as mixtures of C12-14-alcohol having 3 EO and C12-18-alcohol having 5 EO. The degrees of ethoxylation specified are statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols having more than 12 EO. Examples thereof are tallow fatty alcohol having 14 EO, 25 EO, 30 EO or 40 EO.

Particularly preferred are the condensation products of alcohols having an alkyl group containing from about 8 to about 14 carbon atoms with an average of from about 6 to about 8 moles of ethylene oxide per mole of alcohol. Preferably at least 25%, more preferably at least 75% of the surfactant is a straight-chain ethoxylated primary alcohol. It is also preferred that the HLB (hydrophilic-lipophilic balance) of the surfactant be less than about 18, preferably less than about 15 and even more less than 14. Commercially available products for use herein include Lutensol®TO series, C13 oxo alcohol ethoxylated surfactants, supplied by BASF, especially suitable for use herein being Lutensol®TO7.

Other suitable non-ionic surfactants for use herein are C2-C18 alcohol alkoxylate surfactants having EO, PO and/or BO moieties having either random or block distribution. Especially preferred for use herein is a surfactant system comprising an ethoxylated alcohol, preferably a C10-C16 alcohol having from 4 to 10 ethoxy groups. Preferably, the ethoxylated alcohol is in a level of from about 10% to about 80%, preferably from about 20% to about 60% and more preferably from about 30% to about 50% by weight of the surfactant system. It is also preferred that the surfactant system comprises in addition to the ethoxylated alcohol a C2-C18 alcohol alkoxylate having EO, PO and/or BO moieties, specially a C2-C18 alcohol comprising EO and BO moieties in a random configuration. Preferably, the C2-C18 alcohol alkoxylated is in a level of from about 10% to about 80%, preferably from about 20% to about 60% and more preferably from about 30% to about 50% by weight of the surfactant system. Particularly preferred are the following fatty alcohol alkoxylates such as Adekanol B2020 (Adeka), Dehypon LS36 (Cognis), Plurafac LF 221 (C13-15, EO/BO (95%)), Plurafac LF 300, Plurafac LF 303 (EO/PO), Plurafac LF 1300, Plurafac LF224, Degressal SD 20 (polypropoxylate) (all from BASF), Surfonic LF 17 (C12-18 ethoxylated propoxylated alcohol, Huntsman), Triton EF 24 (Dow), Neodol ethoxylates from Shell.

Also suitable for use herein are polyoxyalkene condensates of aliphatic carboxylic acids, whether linear- or branched-chain and unsaturated or saturated, especially ethoxylated and/or propoxylated aliphatic acids containing from about 8 to about 18 carbon atoms in the aliphatic chain and incorporating from about 2 to about 50 ethylene oxide and/or propylene oxide units. Suitable carboxylic acids include coconut” fatty acids (derived from coconut oil) which contain an average of about 12 carbon atoms, “tallow” fatty acids (derived from tallow-class fats) which contain an average of about 18 carbon atoms, palmitic acid, myristic acid, stearic acid and lauric acid.

Also suitable for use herein are polyoxyalkene condensates of aliphatic alcohols, whether linear- or branched-chain and unsaturated or saturated, especially ethoxylated and/or propoxylated aliphatic alcohols containing from about 6 to about 24 carbon atoms and incorporating from about 2 to about 50 ethylene oxide and/or propylene oxide units. Suitable alcohols include “coconut” fatty alcohol, “tallow” fatty alcohol, lauryl alcohol, myristyl alcohol and oleyl alcohol.

Other example types of nonionic surfactants are linear fatty alcohol alkoxylates with a capped terminal group, as described in U.S. Pat. No. 4,340,766 to BASF.

Other example types include olyoxyethylene-polyoxypropylene block copolymers haying formula:

HO(CH2CH2O)a(CH(CH3)CH2O)b(CH2CH2O)cH; or

HO(CH(CH3)CH2O)d(CH2CH2O)e(CH(CH3)CH2O)H

wherein a, b, c, d, e and f are integers from 1 to 350 reflecting the respective polyethylene oxide and polypropylene oxide blocks of said polymer. The polyoxyethylene component of the block polymer constitutes at least about 10% of the block polymer. The material can for instance have a molecular weight of between about 1,000 and about 15,000, more specifically from about 1,500 to about 6,000. These materials are well-known in the art. They are available under the trademark “Pluronic” and “Pluronic R”, from BASF Corporation.

Suitable non-ionic surfactants for use herein are epoxy-capped poly(oxyalkylated) alcohols represented by the formula:

R1O[CH2CH(CH3)O]x[CH2CH2O]y[CH2CH(OH)R2] (I)

wherein R1 is a linear or branched, aliphatic hydrocarbon radical having from 4 to 18 carbon atoms; R2 is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20.

Preferably, the surfactant of formula I, at least about 10 carbon atoms in the terminal epoxide unit [CH2CH(OH)R2]. Suitable surfactants of formula I, according to the present invention, are Olin Corporation's POLY-TERGENT® SLF-18B nonionic surfactants, as described, for example, in WO 94/22800, published Oct. 13, 1994 by Olin Corporation.

Preferably a non-ionic surfactant suitable for use herein has a Draves wetting time of less than 360 seconds, preferably less than 200 seconds, more preferably less than 100 seconds and especially less than 60 seconds as measured by the Draves wetting method (standard method ISO 8022 using the following conditions; 3-g hook, 5-g cotton skein, 0.1% by weight aqueous solution at a temperature of 25° C.).

Amine oxides surfactants are also useful here in. They include linear and branched compounds having the formula:

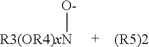

wherein R3 is selected from an alkyl, hydroxyalkyl, acylamidopropoyl and alkyl phenyl group, or mixtures thereof, containing from 8 to 26 carbon atoms, preferably 8 to 18 carbon atoms; R4 is an alkylene or hydroxyalkylene group containing from 2 to 3 carbon atoms, preferably 2 carbon atoms, or mixtures thereof; x is from 0 to 5, preferably from 0 to 3; and each R5 is an alkyl or hydroxyalkyl group containing from 1 to 3, preferably from 1 to 2 carbon atoms, or a polyethylene oxide group containing from 1 to 3, preferable 1, ethylene oxide groups. The R5 groups can be attached to each other, e.g., through an oxygen or nitrogen atom, to form a ring structure.

These amine oxide surfactants in particular include C10-C18 alkyl dimethyl amine oxides and C8-C18 alkoxy ethyl dihydroxyethyl amine oxides. Examples of such materials include dimethyloctylamine oxide, diethyldecylamine oxide, bis-(2-hydroxyethyl)dodecylamine oxide, dimethyldodecylamine oxide, dipropyltetradecylamine oxide, methylethylhexadecylamine oxide, dodecylamidopropyl dimethylamine oxide, cetyl dimethylamine oxide, stearyl dimethylamine oxide, tallow dimethylamine oxide and dimethyl-2-hydroxyoctadecylamine oxide. Preferred are C10-C18 alkyl dimethylamine oxide, and C10-18 acylamido alkyl dimethylamine oxide.

### Other Cleaning Actives

Any cleaning ingredient in addition to the non-ionic surfactant can be used as part of the product of the invention. The levels given are weight percent and refer to the total composition (excluding the enveloping water-soluble material, in the case of unit dose forms having a wrapper or enveloping material). The composition can contain in addition to the non-ionic surfactant a phosphate builder or be free of phosphate builder and comprise one or more detergent active components which may be selected from enzyme, bleach, bleach activator, bleach catalyst, alkalinity sources, anti-scalant polymer, dying aids, anti-corrosion agents (e.g. sodium silicate) and care agents. Highly preferred cleaning components for use herein include a builder compound, a bleach, an alkalinity source, a surfactant, an anti-scaling polymer (preferably a sulfonated polymer), an enzyme and an additional bleaching agent.

### Builder

Builders for use herein include phosphate builders and phosphate free builders. If present, builders are used in a level of from 5 to 60%, preferably from 10 to 50%, more preferably from 20 to 50% by weight of the composition. In some embodiments the product comprises a mixture of phosphate and non-phosphate builders.

### Phosphate Builders

Preferred phosphate builders include mono-phosphates, di-phosphates, tri-polyphosphates or oligomeric-poylphosphates are used. The alkali metal salts of these compounds are preferred, in particular the sodium salts. An especially preferred builder is sodium tripolyphosphate (STPP).

### Non-Phosphate Builders

Preferred non-phosphate builders include amino acid based compounds, in particular MGDA (methyl-glycine-diacetic acid), and salts and derivatives thereof, GLDA (glutamic-N,N-diacetic acid) and salts and derivatives thereof, IDS (iminodisuccinic acid) and salts and derivatives thereof, carboxy methyl inulin and salts and derivatives thereof and mixtures thereof. GLDA (salts and derivatives thereof) is especially preferred according to the invention, with the tetrasodium salt thereof being especially preferred. Preferably MGDA or GLDA are present in the composition of the invention in a level of from 0.5% to 40%, more preferably from about 1% to about 35% and especially from about 2 to about 10% by weight of the composition.

Suitable builders for use herein, in addition or instead of MGDA and/or GLDA, include builders which forms water-soluble hardness ion complexes (sequestering builder) such as citrates and builders which forms hardness precipitates (precipitating builder) such as carbonates e.g. sodium carbonate.

Other suitable non-phosphate builders include amino acid based compound or a succinate based compound. The term “succinate based compound” and “succinic acid based compound” are used interchangeably herein. Other suitable builders are described in U.S. Pat. No. 6,426,229. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), alpha-alanine-N,N-diacetic acid (alpha-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof.

Preferably the non-phosphate builder is present in the composition in an amount of at least 1%, more preferably at least 5%, even more preferably at least 10%, and most especially at least 20% by weight of the total composition. Preferably these builders are present in an amount of up to 50%, more preferably up to 45%, even more preferably up to 40%, and especially up to 35% by weight of the total composition. In preferred embodiments the composition contains 20% by weight of the total composition or less of phosphate builders, more preferably 10% by weight of the total composition or less, most preferably they are substantially free of phosphate builders.

Other non-phosphate builders include homopolymers and copolymers of polycarboxylic acids and their partially or completely neutralized salts, monomeric polycarboxylic acids and hydroxycarboxylic acids and their salts. Preferred salts of the abovementioned compounds are the ammonium and/or alkali metal salts, i.e. the lithium, sodium, and potassium salts, and particularly preferred salts are the sodium salts.

Suitable polycarboxylic acids are acyclic, alicyclic, heterocyclic and aromatic carboxylic acids, in which case they contain at least two carboxyl groups which are in each case separated from one another by, preferably, no more than two carbon atoms. Polycarboxylates which comprise two carboxyl groups include, for example, water-soluble salts of, malonic acid, (ethyl enedioxy) diacetic acid, maleic acid, diglycolic acid, tartaric acid, tartronic acid and fumaric acid. Polycarboxylates which contain three carboxyl groups include, for example, water-soluble citrate. Correspondingly, a suitable hydroxycarboxylic acid is, for example, citric acid. Another suitable polycarboxylic acid is the homopolymer of acrylic acid. Other suitable builders are disclosed in WO 95/01416, to the contents of which express reference is hereby made.

### Anti-Scalant Polymer

The polymer, if present, is used in any suitable amount from about 0.1% to about 50%, preferably from 0.5% to about 20%, more preferably from 1% to 10% by weight of the composition.

Preferred organic polymers herein include acrylic acid containing polymers such as Sokalan PA30, PA20, PA15, PA10 and Sokalan CP10 (BASF GmbH), Acusol 45N, 480N, 460N (Rohm and Haas), acrylic acid/maleic acid copolymers such as Sokalan CP5 and acrylic/methacrylic copolymers. Preferred soil release polymers herein include alkyl and hydroxyalkyl celluloses (U.S. Pat. No. 4,000,093), polyoxyethylenes, polyoxypropylenes and copolymers thereof, and nonionic and anionic polymers based on terephthalate esters of ethylene glycol, propylene glycol and mixtures thereof.

Sulfonated/carboxylated polymers can also be suitable for the composition of the invention.

Suitable sulfonated/carboxylated polymers described herein may have a weight average molecular weight of less than or equal to about 100,000 Da, or less than or equal to about 75,000 Da, or less than or equal to about 50,000 Da, or from about 3,000 Da to about 50,000, preferably from about 5,000 Da to about 10,000 Da.

As noted herein, the sulfonated/carboxylated polymers may comprise (a) at least one structural unit derived from at least one carboxylic acid monomer having the general formula (I):

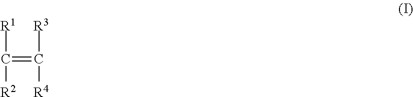

wherein R1 to R4 are independently hydrogen, methyl, carboxylic acid group or CH2COOH and wherein the carboxylic acid groups can be neutralized; (b) optionally, one or more structural units derived from at least one nonionic monomer having the general formula (II):

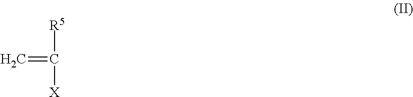

wherein R5 is hydrogen, C1 to C6 alkyl, or C1 to C6 hydroxyalkyl, and X is either aromatic (with R5 being hydrogen or methyl when X is aromatic) or X is of the general formula (III):

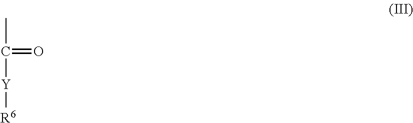

wherein R6 is (independently of R5) hydrogen, C1 to C6 alkyl, or C1 to C6 hydroxyalkyl, and Y is O or N; and at least one structural unit derived from at least one sulfonic acid monomer having the general formula (IV):

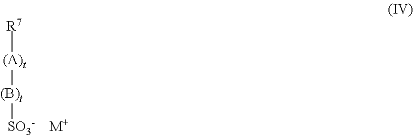

wherein R7 is a group comprising at least one sp2 bond, A is O, N, P, S or an amido or ester linkage, B is a mono- or polycyclic aromatic group or an aliphatic group, each t is independently 0 or 1, and M+ is a cation. In one aspect, R7 is a C2 to C6 alkene. In another aspect, R7 is ethene, butene or propene.

Preferred carboxylic acid monomers include one or more of the following: acrylic acid, maleic acid, itaconic acid, methacrylic acid, or ethoxylate esters of acrylic acids, acrylic and methacrylic acids being more preferred. Preferred sulfonated monomers include one or more of the following: sodium (meth) allyl sulfonate, vinyl sulfonate, sodium phenyl (meth) allyl ether sulfonate, or 2-acrylamido-methyl propane sulfonic acid. Preferred non-ionic monomers include one or more of the following: methyl (meth)acrylate, ethyl (meth)acrylate, t-butyl (meth) acrylate, methyl (meth) acrylamide, ethyl (meth) acrylamide, t-butyl (meth) acrylamide, styrene, or α-methyl styrene.

Preferably, the polymer comprises the following levels of monomers: from about 40 to about 90%, preferably from about 60 to about 90% by weight of the polymer of one or more carboxylic acid monomer; from about 5 to about 50%, preferably from about 10 to about 40% by weight of the polymer of one or more sulfonic acid monomer; and optionally from about 1% to about 30%, preferably from about 2 to about 20% by weight of the polymer of one or more non-ionic monomer. An especially preferred polymer comprises about 70% to about 80% by weight of the polymer of at least one carboxylic acid monomer and from about 20% to about 30% by weight of the polymer of at least one sulfonic acid monomer.

The carboxylic acid is preferably (meth)acrylic acid. The sulfonic acid monomer is preferably one of the following: 2-acrylamido methyl-1-propanesulfonic acid, 2-methacrylamido-2-methyl-1-propanesulfonic acid, 3-methacrylamido-2-hydroxypropanesulfonic acid, allysulfonic acid, methallysulfonic acid, allyloxybenzenesulfonic acid, methallyloxybenzensulfonic acid, 2-hydroxy-3-(2-propenyloxy)propanesulfonic acid, 2-methyl-2-propene-1-sulfonic acid, styrene sulfonic acid, vinylsulfonic acid, 3-sulfopropyl acrylate, 3-sulfopropyl methacrylate, sulfomethylacrylamid, sulfomethylmethacrylamide, and water soluble salts thereof. The unsaturated sulfonic acid monomer is most preferably 2-acrylamido-2-propanesulfonic acid (AMPS).

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Rohm & Haas; Goodrich K-798, K-775 and K-797 supplied by BF Goodrich; and ACP 1042 supplied by ISP technologies Inc. Particularly preferred polymers are Acusol 587G and Acusol 588G supplied by Rohm & Haas.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

Other suitable anti-scalant polymer for use herein includes a polymer comprising an acrylic acid backbone and alkoxylated side chains, said polymer having a molecular weight of from about 2,000 to about 20,000, and said polymer having from about 20 wt % to about 50 wt % of an alkylene oxide. The polymer should have a molecular weight of from about 2,000 to about 20,000, or from about 3,000 to about 15,000, or from about 5,000 to about 13,000. The alkylene oxide (AO) component of the polymer is generally propylene oxide (PO) or ethylene oxide (EO) and generally comprises from about 20 wt % to about 50 wt %, or from about 30 wt % to about 45 wt %, or from about 30 wt % to about 40 wt % of the polymer. The alkoxylated side chains of the water soluble polymers may comprise from about 10 to about 55 AO units, or from about 20 to about 50 AO units, or from about 25 to 50 AO units. The polymers, preferably water soluble, may be configured as random, block, graft, or other known configurations. Methods for forming alkoxylated acrylic acid polymers are disclosed in U.S. Pat. No. 3,880,765.

### Drying Aids

Preferred drying aids for use herein include polyesters, especially anionic polyesters formed from monomers of terephthalic acid, 5-sulphoisophthalic acid, alkyl diols or polyalkylene glycols, and, polyalkyleneglycol monoalkylethers. Suitable polyesters to use as drying aids are disclosed in WO 2008/110816. Other suitable drying aids include specific polycarbonate-, polyurethane- and/or polyurea-polyorganosiloxane compounds or precursor compounds thereof of the reactive cyclic carbonate and urea type, as described in WO 2008/119834.

Improved drying can also be achieved by a process involving the delivery of surfactant and an anionic polymer as proposed in WO 2009/033830 or by combining a specific non-ionic surfactant in combination with a sulfonated polymer as proposed in WO 2009/033972.

Preferably the composition of the invention comprises from 0.1% to 10%, more preferably from 0.5 to 5% and especially from 1% to 4% by weight of the composition of a drying aid.

### Silicates

Preferred silicates are sodium silicates such as sodium disilicate, sodium metasilicate and crystalline phyllosilicates. Silicates if present are at a level of from about 1 to about 20%, preferably from about 5 to about 15% by weight of composition.

### Bleach

Inorganic and organic bleaches are suitable cleaning actives for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated.

Alkali metal percarbonates, particularly sodium percarbonate are preferred perhydrates for use herein. The percarbonate is most preferably incorporated into the products in a coated form which provides in-product stability. A suitable coating material providing in product stability comprises mixed salt of a water-soluble alkali metal sulphate and carbonate. Such coatings together with coating processes have previously been described in GB-1,466,799. The weight ratio of the mixed salt coating material to percarbonate lies in the range from 1:200 to 1:4, more preferably from 1:99 to 1 9, and most preferably from 1:49 to 1:19. Preferably, the mixed salt is of sodium sulphate and sodium carbonate which has the general formula Na2SO4.n.Na2CO3 wherein n is from 0.1 to 3, preferably n is from 0.3 to 1.0 and most preferably n is from 0.2 to 0.5.

Another suitable coating material providing in product stability, comprises sodium silicate of SiO2:Na2O ratio from 1.8:1 to 3.0:1, preferably L8:1 to 2.4:1, and/or sodium metasilicate, preferably applied at a level of from 2% to 10%, (normally from 3% to 5%) of SiO2 by weight of the inorganic perhydrate salt. Magnesium silicate can also be included in the coating. Coatings that contain silicate and borate salts or boric acids or other inorganics are also suitable.

Other coatings which contain waxes, oils, fatty soaps can also be used advantageously within the present invention.

Potassium peroxymonopersulfate is another inorganic perhydrate salt of utility herein.

Typical organic bleaches are organic peroxyacids including diacyl and tetraacylperoxides, especially diperoxydodecanedioc acid, diperoxytetradecanedioc acid, and diperoxyhexadecanedioc acid. Dibenzoyl peroxide is a preferred organic peroxyacid herein. Mono- and diperazelaic acid, mono- and diperbrassylic acid, and Nphthaloylaminoperoxicaproic acid are also suitable herein.

The diacyl peroxide, especially dibenzoyl peroxide, should preferably be present in the form of particles having a weight average diameter of from about 0.1 to about 100 microns, preferably from about 0.5 to about 30 microns, more preferably from about 1 to about 10 microns. Preferably, at least about 25%, more preferably at least about 50%, even more preferably at least about 75%, most preferably at least about 90%, of the particles are smaller than 10 microns, preferably smaller than 6 microns. Diacyl peroxides within the above particle size range have also been found to provide better stain removal especially from plastic dishware, while minimizing undesirable deposition and filming during use in automatic dishwashing machines, than larger diacyl peroxide particles. The preferred diacyl peroxide particle size thus allows the formulator to obtain good stain removal with a low level of diacyl peroxide, which reduces deposition and filming. Conversely, as diacyl peroxide particle size increases, more diacyl peroxide is needed for good stain removal, which increases deposition on surfaces encountered during the dishwashing process.

Further typical organic bleaches include the peroxy acids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, 8-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators if included in the compositions of the invention are in a level of from about 0.1 to about 10%, preferably from about 0.5 to about 2% by weight of the total composition.

### Bleach Catalyst

Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410). A complete description of bleach catalysts suitable for use herein can be found in WO 99/06521, pages 34, line 26 to page 40, line 16. Bleach catalyst if included in the compositions of the invention are in a level of from about 0.1 to about 10%, preferably from about 0.5 to about 2% by weight of the total composition.

### Enzymes

### Enzyme Related Terminology

### Nomenclature for Amino Acid Modifications

In describing enzyme variants herein, the following nomenclature is used for ease of reference: Original amino acid(s):position(s):substituted amino acid(s).

According to this nomenclature, for instance the substitution of glutamic acid for glycine in position 195 is shown as G195E. A deletion of glycine in the same position is shown as G195*, and insertion of an additional amino acid residue such as lysine is shown as G195GK. Where a specific enzyme contains a “deletion” in comparison with other enzyme and an insertion is made in such a position this is indicated as *36D for insertion of an aspartic acid in position 36. Multiple mutations are separated by pluses, i.e.: S99G+V102N, representing mutations in positions 99 and 102 substituting serine and valine for glycine and asparagine, respectively. Where the amino acid in a position (e.g. 102) may be substituted by another amino acid selected from a group of amino acids, e.g. the group consisting of N and I, this will be indicated by V102N/I.

In all cases, the accepted IUPAC single letter or triple letter amino acid abbreviation is employed.

### Protease Amino Acid Numbering

The numbering used herein is numbering versus the so-called BPN′ numbering scheme which is commonly used in the art and is illustrated for example in WO00/37627.

### Amino Acid Identity

The relatedness between two amino acid sequences is described by the parameter “identity”. For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

The degree of identity between an amino acid sequence of and enzyme used herein (“invention sequence”) and a different amino acid sequence (“foreign sequence”) is calculated as the number of exact matches in an alignment of the two sequences, divided by the length of the “invention sequence” or the length of the “foreign sequence”, whichever is the shortest. The result is expressed in percent identity. An exact match occurs when the “invention sequence” and the “foreign sequence” have identical amino acid residues in the same positions of the overlap. The length of a sequence is the number of amino acid residues in the sequence.

Preferred enzyme for use herein includes a protease. Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:

(a) subtilisins (EC 3.4.21.62), including those derived from Bacillus, such as Bacillus lentus, B. alkalophilus, B. subtilis, B. amyloliquefaciens, Bacillus pumilus and Bacillus gibsonii described in U.S. Pat. No. 6,312,936 B1, U.S. Pat. No. 5,679,630, U.S. Pat. No. 4,760,025, U.S. Pat. No. 7,262,042 and WO09/021,867.
(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.
(c) metalloproteases, including those derived from Bacillus amyloliquefaciens described in WO 07/044,993A2.

Preferred proteases include those derived from Bacillus gibsonii or Bacillus Lentus.

Preferred proteases for use herein include polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627, which is incorporated herein by reference:

68, 87, 99, 101, 103, 104, 118, 128, 129, 130, 167, 170, 194, 205 & 222 and optionally one or more insertions in the region comprising amino acids 95-103.

Preferably, the mutations are selected from one or more, preferably two or more and more preferably three or more of the following: V68A, N87S, S99D, S99SD, S99A, S101G, S103A, V104N/I, Y167A, R170S, A194P, V2051 and/or M222S.

Most preferably the protease is selected from the group comprising the below mutations (BPN′ numbering system) versus either the PB92 wild-type (SEQ ID NO: 2 in WO 08/010,925) or the subtilisin 309 wild-type (sequence as per PB92 backbone, except comprising a natural variation of N87S).

### (i) G118V+S128L+P129Q+5130A

### (ii) G118V+S128N+P129S+5130A+S166D

(iii) G118V+S128L+P129Q+S130A+S166D

### (iv) G118V+S128V+P129E+5130K

### (v) G118V+S128V+P129M+S166D

### (vi) G118V+S128F+P129L+5130T

(vii) G118V+S128L+P129N+S130V
(viii) G118V+S128F+P129Q

### (ix) G118V+S128V+P129E+S130K+S166D

### (x) G118V+S128R+P129S+5130P

### (xi) S128R+P129Q+S130D

(xii) S128C+P129R+S130D
(xiii) S128C+P129R+S130G
(xiv) S101G+V104N

### (xv) N76D+N87S+S103A+V104I

(xvi) V68A+N87S+S101G+V104N
(xvii) S99SD+S99A
(xviii) N87S+S99SD+S99A

Suitable commercially available protease enzymes include those sold under the trade names Alcalase®, Savinase®, Primase®, Durazym®, Polarzyme®, Kannase®, Liquanase®, Ovozyme®, Neutrase®, Everlase® and Esperase® by Novozymes A/S (Denmark), those sold under the tradename Maxatase®, Maxacal®, Maxapem®, Properase®, Purafect®, Purafect Prime®, Purafect Ox®, FN3®, FN4®, Excellase® and Purafect OXP® by Genencor International, those sold under the tradename Opticlean® and Optimase® by Solvay Enzymes, those available from Henkel/Kemira, namely BLAP (sequence shown in FIG. 29 of U.S. Pat. No. 5,352,604 with the following mutations S99D+S101R+S103A+V1041+G159S, hereinafter referred to as BLAP), BLAP R (BLAP with S3T+V4I+V199M+V2051+L217D), BLAP X (BLAP with S3T+V4I+V2051) and BLAP F49 (BLAP with S3T+V4I+A194P+V199M+V2051+L217D)—all from Henkel/Kemira; and KAP (Bacillus alkalophilus subtilisin with mutations A230V+S256G+S259N) from Kao.

Preferred levels of protease in the compositions of the invention include from about 0.1 to about 10, more preferably from about 0.5 to about 5 and especially from about 1 to about 4 mg of active protease per grams of composition.

Preferred enzyme for use herein includes alpha-amylases, including those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:

(a) the variants described in WO 94/02597, WO 94/18314, WO96/23874 and WO 97/43424, especially the variants with substitutions in one or more of the following positions versus (the enzyme listed as SEQ ID NO: 2 in WO 96/23874): 15, 23, 105, 106, 124, 128, 133, 154, 156, 181, 188, 190, 197, 202, 208, 209, 243, 264, 304, 305, 391, 408, and 444.
(b) the variants described in U.S. Pat. No. 5,856,164 and WO99/23211, WO 96/23873, WO00/60060 and WO 06/002643, especially the variants with one or more substitutions in the following positions versus (the AA560 enzyme listed as SEQ ID NO: 12 in WO 06/002643): 26, 30, 33, 82, 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, preferably that also contain the deletions of D183* and G184*.
(c) variants exhibiting at least 90% identity with (SEQ ID NO: 4 in WO06/002643), the wild-type enzyme from Bacillus SP722, especially variants with deletions in the 183 and 184 positions and variants described in WO 00/60060, which is incorporated herein by reference.
(d) variants exhibiting at least 95% identity with (the wild-type enzyme from Bacillus sp. 707 SEQ ID NO: 7 in U.S. Pat. No. 6,093,562), especially those comprising one or more of the following mutations M202, M208, 5255, R172, and/or M261. Preferably said amylase comprises one or more of M202L, M202V, M2025, M202T, M202I, M202Q, M202W, S255N and/or R172Q. Particularly preferred are those comprising the M202L or M202T mutations.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS® and PURASTAR OXAM® (Genencor International Inc., Palo Alto, Calif.) and KAM® (Kao, 14-10 Nihonbashi Kayabacho, 1-chome, Chuo-ku Tokyo 103-8210, Japan). In one aspect, suitable amylases include NATALASE®, STAINZYME® and STAINZYME PLUS® and mixtures thereof.

Preferably, the composition of the invention comprises at least 0.01 mg of active alpha-amylases per gram of composition, preferably from about 0.05 to about 10, more preferably from about 0.1 to about 6, especially from about 0.2 to about 4 mg of alpha-amylases per gram of composition.

### Metal Care Agents

Metal care agents may prevent or reduce the tarnishing, corrosion or oxidation of metals, including aluminium, stainless steel and non-ferrous metals, such as silver and copper. Suitable examples include one or more of the following:

(a) benzatriazoles, including benzotriazole or bis-benzotriazole and substituted derivatives thereof. Benzotriazole derivatives are those compounds in which the available substitution sites on the aromatic ring are partially or completely substituted. Suitable substituents include linear or branch-chain C1-C20-alkyl groups and hydroxyl, thio, phenyl or halogen such as fluorine, chlorine, bromine and iodine.
(b) metal salts and complexes chosen from the group consisting of zinc, manganese, titanium, zirconium, hafnium, vanadium, cobalt, gallium and cerium salts and/or complexes, the metals being in one of the oxidation states II, III, IV, V or VI. In one aspect, suitable metal salts and/or metal complexes may be chosen from the group consisting of Mn(II) sulphate, Mn(II) citrate, Mn(II) stearate, Mn(II) acetylacetonate, K2TiF6, K2ZrF6, CoSO4, Co(NO3)2 and Ce(NO3)3, zinc salts, for example zinc sulphate, hydrozincite or zinc acetate.
(c) silicates, including sodium or potassium silicate, sodium disilicate, sodium metasilicate, crystalline phyllosilicate and mixtures thereof.

Further suitable organic and inorganic redox-active substances that act as silver/copper corrosion inhibitors are disclosed in WO 94/26860 and WO 94/26859.

Preferably the composition of the invention comprises from 0.1 to 5%, more preferably from 0.2 to 4% and specially from 0.3 to 3% by weight of the total composition of a metal care agent, preferably the metal care agent is a zinc salt.

### Unit Dose Form

Preferably the product of the invention is a unit-dose product. Products in unit dose form include tablets, capsules, sachets, pouches, etc. Preferred for use herein are tablets and unit dose form wrapped with a water-soluble film (including wrapped tablets, capsules, sachets, pouches) and injection moulded containers. The unit dose form of the invention is preferably a water-soluble multi-compartment pack.

Preferably, at least one of the compartments contains a solid composition and another compartment a composition in gel form, the compositions are preferably in a solid to gel weight ratio of from about 20:1 to about 1:20, more preferably from about 18:1 to about 2:1 and even more preferably from about 15:1 to about 5:1. Particularly preferred have been found to be pouches having a high solid:gel ratio because many of the detergent ingredients are most suitable for use in solid form, preferably in powder form. The ratio solid:gel defined herein refers to the relationship between the weight of all the solid compositions and the weight of all the gel compositions in the pack. Preferably solid:gel weight ratio is from about 2:1 to about 18:1, more preferably from about 5:1 to about 15:1.

For dispenser fit reasons, especially in an automatic dishwasher, the unit dose form products herein have a square or rectangular base and a height of from about 1 to about 5 cm, more preferably from about 1 to about 4 cm. Preferably the weight of the solid composition is from about 5 to about 20 grams, more preferably from about 10 to about 15 grams and the weight of the liquid compositions is from about 0.5 to about 4 grams, more preferably from about 0.8 to about 3 grams.

In preferred embodiments, at least two of the films which form different compartments have different solubility, under the same conditions, releasing the content of the compositions which they partially or totally envelope at different times.

Controlled release of the ingredients of a multi-compartment pouch can be achieved by modifying the thickness of the film and/or the solubility of the film material. The solubility of the film material can be delayed by for example cross-linking the film as described in WO 02/102,955 at pages 17 and 18. Other water-soluble films designed for rinse release are described in U.S. Pat. No. 4,765,916 and U.S. Pat. No. 4,972,017. Waxy coating (see WO 95/29982) of films can help with rinse release. pH controlled release means are described in WO 04/111178, in particular amino-acetylated polysaccharide having selective degree of acetylation.

Other means of obtaining delayed release by multi-compartment pouches with different compartments, where the compartments are made of films having different solubility are taught in WO 02/08380.

### EXAMPLES

The compositions tabulated below are introduced into a dual-compartment water-soluble pack having a first compartment comprising the solid composition (in powder form) and a liquid compartment comprising the liquid compositions. The water-soluble film used is Monosol M8630 film as supplied by Monosol. The weight of the solid composition is 17 grams and the weight of liquid compositions is 2.6 gram.

| | Formulation | | |
|---|---|---|---|
| | 1 | 2 | 3 |
| Ingredient | Level (% wt) | Level (% wt) | Level (% wt) |
| Solid composition | | | |
| STPP | 55 | 27 | 0 |
| Carbonate | 18 | 19 | 35 |
| Citrate | 0 | 15 | 27 |
| Silicate | 2 | 1.5 | 7 |
| TAED | 4 | 8 | 10 |
| Zinc carbonate | 0.5 | 0.5 | 0 |
| LF224 | 0.5 | 1.5 | 0.5 |
| Bleach catalyst (1% active) | 0.5 | 0.5 | 0 |
| Percarbonate | 11 | 16 | 18 |
| 588 | 6 | 8 | 0 |
| Protease (100 mg/g active) | 2.1 | 2.0 | 1.8 |
| Amylase (14.4 mg/g active) | 0.8 | 1.2 | 0.7 |
| Processing aids and sodium | To balance | To balance | To balance |
| sulphate | | | |
| Liquid composition | | | |
| TO7 | 48 | 48 | 48 |
| LF224 | 33 | 33 | 33 |
| Neodol 1-9 | 1.5 | 1.5 | 1.5 |
| Glycerine | 3 | 3 | 3 |
| DPG | 13 | 13 | 13 |
| Processing aids | To balance | To balance | To balance |

TO7: Non-ionic surfactant available from BASF
LF224: Non-ionic surfactant available from BASF
Neodol 1-9: Non-ionic surfactant available from BASF.
588: Acusol 588G sulfonated polymer supplied by Rohm & Haas

The exemplified compositions are used to clean a soiled dishwashing load. Twenty five cycles are run. The pipes leading from and to the dishwasher pumps are inspected. No visible residues are found. Referring to FIG. 1, an example of the obscuration of 417 ppm of Brij 30 in the presence of 574 ppm of sodium carbonate and 1896 ppm of sodium tripolyphosphate is shown.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention

What is claimed is:

1. Use of an automatic dishwashing product in an automatic dishwasher for cleaning the internal parts of a dishwasher during an automatic dishwashing operation wherein the operation involves the delivery of at least 250 ppm of a non-ionic surfactant.

2. Use according to claim 1 wherein the non-ionic surfactant in the presence of 0.75 grams of lard and subjected to a 30-50-20° C. temperature cycle has an obscuration at 20° C. greater than the obscuration at 36° C. within the cooling phase of the cycle.

3. Use according to claim 1 wherein the non-ionic surfactant in the presence of 0.75 grams and subjected to a 30-50-20° C. temperature cycle has a normalized obscuration index of at least about 0.5 wherein the obscuration index is the ratio of obscuration at 36° within the cooling phase of the cycle to the obscuration at 20° C. when subjected to a 30-50-20° C. cycle.

4. Use according to claim 1 wherein the non-ionic surfactant has an interfacial tension decay constant on lard at 50° C. of less than 1.2 seconds and an equilibrium interfacial tension of less than 1.4 mN/m.

5. Use according to claim 1 wherein the non-ionic surfactant has a cloud point in the range of from 20° C. to 50° C.

6. Use according to claim 1 wherein the non-ionic surfactant is a low foaming non-ionic surfactant.

7. Use according to claim 1 wherein the non-ionic surfactant is a surfactant system comprising at least 30% of an alcohol ethoxylated surfactant by weight of the surfactant system and less than 50% by weight of the surfactant system of an alkoxylated alcohol surfactant comprising at least two alkoxylated groups selected from EO, PO and BO.

8. A phosphate free automatic dishwashing product capable of providing cleaning of the internal parts of a dishwasher comprising at least 7% by weight of the composition of a non-ionic surfactant, bleach, and an anti-scalant polymer.

9. An automatic dishwashing product in unit dose form capable of providing cleaning of the internal parts of a dishwasher comprising at least 7% by weight of the composition of a non-ionic surfactant wherein the product is selected from: a multi-phase tablet comprising an insert; a single compartment pouch; or a multi-compartment pouch wherein one of the compartments comprises a composition in gel form.

10. An automatic dishwashing product in the form of a water-soluble pouch capable of providing cleaning of the internal parts of a dishwasher comprising at least 7% by weight of the composition of a non-ionic surfactant, an oxygen bleach and a manganese bleach catalyst.

11. A method of automatic dishwashing comprising cleaning the internal parts of a dishwasher during a dishwashing operation comprising the step of delivering a detergent composition capable of providing at least 250 ppm of non-ionic surfactant using the product of claim 8.
